(19) United States
(12) Patent Application Publication
(10) Pub. No.: US 2002/0184075 A1
(43) Pub. Date: Dec. 5, 2002

(54) Method and system for market segmentation

(76) Inventors: Paul T. Hertz, Miami Beach, FL (US); Debra Levine Hertz, Miami Beach, FL (US)

Correspondence Address: LOTT & FRIEDLAND, P.A., P.O. BOX 141098, CORAL GABLES, FL, 33114-1098, US

(21) Appl. No.: 09/871,437

(22) Filed: May 31, 2001

(51) Int. Cl. G06F 17/60

(52) U.S. Cl. 705/10; 705/14

(57) ABSTRACT

A method and system of personality typing for market segmentation purposes. Whereby the segment personality type characteristics can be analyzed for providing the most effective, targeted decisions regarding that segment. Analysis of the market is achieved primarily by using an enneagram to determine prints, and further refined by Jungian testing, for example, Myers-Briggs type testing.

### FIELD OF INVENTION

The present invention relates generally to marketing, and more particularly, to a method and system of personality typing for market segmentation purposes, whereby the segment personality type characteristics can be analyzed for providing the most effective, targeted decisions regarding that segment.

### BACKGROUND OF THE INVENTION

Market segmentation is a broad term used in market research that covers a host of different possible approaches to analyzing customers. Broadly speaking, it focuses on dividing customers into groups that can be further analyzed for a number of different issues. Approaches to developing market segments usually fall into one of three broad groups, including Company Defined Segments, Single Attribute Segments and Multi-Attribute Segments.

Company defined segments are typically created for the convenience of the company. They often have little to do with the customer except for some gross, overall facts regarding the relationship of the customer with the company. Conceptually at least, there is often some overlap between this approach and the Single Attribute Segmentation model discussed below. Company-defined segments tend to be crude and derived from internal data, and may have elements of a demographic focus. Examples of this sort of approach include:

1. Segmenting customers by product used (e.g., natural gas customer, electricity customer), where the customer list for each product becomes a segment;

2. Segmenting customers by company size (e.g., retail banking, small business banking, middle market, large corporate), where the key-defining factor is the total sales of the customer company—regardless of the amount of business that they do with the financial institution;

3. Segmentation of customers by industry (e.g., SIC Codes), where all customers within a specific industry are presumed to be similar; and,

4. Segmenting by geography (e.g., region, divisions), where the responsible parties within the company are assigned customers.

Most often, company-oriented segmentation models revolve around highly objective information that is internally collected by the company. Alternatively, purchased data (e.g., Dun & Bradstreet data) may be used to create the segmentation model. While possible, survey data are rarely used in creating company-defined segments. Indeed, from the company's perspective, this is one of the primary benefits. The simple segmentation model can be applied to all customers, and it is constantly maintained and updated as an internal corporate process.

Most company-defined segments are also single-attribute segments in that they focus on one—and only one—customer characteristic. The key issue that distinguishes single attribute models from company-defined models is the source of the data. Typically, the single attribute models collect some greater amount of information about the customer, and this information is used as the basis of the segmentation plan. The greater amount of information collected about the customer usually adds a psychological or behavioral component. Examples of single attribute segmentation models include:

1. Overall Product Orientation, defined as Product Acceptors, Product Rejecters, and Non-Users. The key issue revolves around the use status vis a vis a specific product or product group, and emphasizes a psychological component of “acceptance”; and,

2. Volume of Product Use shifts the perspective from psychological to behavioral, and emphasizes the amount of the product used.

Customer Satisfaction segments can be formed from a single “overall satisfaction” question, with respondents classified as Delighted, Satisfied, Ambivalent, and At Risk.

Single attribute segmentation models may be developed from corporate data or from simple survey data. Typically, little if any statistical analysis of the data is required to create these models; the segments are simply created from the data elements. If created from internal data, then a single attribute segmentation model can be developed In general, multi-attribute segmentation models more accurately reflect the general goals that companies have when embarking on a program to segment their customer base. Most purchase decisions are not made on the basis of one single characteristic. More commonly, customers bring a host of different concerns into the picture when considering a purchase. The company that identifies the unique profiles that customers have across all of these characteristics when considering a purchase will do a better job of designing products that are tailored to their needs, and communicating their unique competitive advantage to potential customers.

Multi-attribute segmentation models are used in a wide variety of areas. While usually developed on the basis of survey data, it is also possible to develop these models on the basis of internal company databases. Some examples of multi-attribute segmentation models include:

1. Product Use models, where the volume of sales across multiple product lines is used to develop the segmentation scheme. A key benefit of this approach is the identification of opportunities for cross-selling;

2. Customer Satisfaction models, where the segments are based on the key drivers of overall satisfaction with the company and its products. These models permit identification of totally disenchanted customers who are upset with all or most of the key drivers versus those who have unique, targeted concerns;

3. Product Design segmentation models can be developed from conjoint analysis studies to identify groups for whom different product characteristics are most important. Rather than developing a single product, product lines that vary in specific features can be developed using this approach; and,

4. Attitude and Behavior models seek to maximize sales penetration by linking attitudinal data with the customers'behaviors. Marketing messages are tailored based on the attitudinal information of the best customer segments, and these messages are targeted at potential customers who share the same attitude but have not yet purchased the product(s). These four are merely examples; a host of other areas are also applicable. Multi-attribute segmentation models are usually developed as one of the final stages of an extensive statistical analysis. These models are usually created using either agglomerative or splitting methods of cluster analysis, of which there are many different specific methods, each with their own unique strengths and ability to capture different nuances in the data.

Multi-attribute segmentation models are complex but give you the best overall picture of your customers. The complexity of the model mirrors the complexity of the decision making process that customers use when making purchase decisions, and it is this fact that gives these models their power.

The reason for segmenting is that customers within segments have more in common with each other than with customers in the remaining segments. This communality helps focus marketing efforts toward each segment. Basically, customers who share similar characteristics on key defining attributes have similar needs, and this similarity allows development of specialized products and/or messages that uniquely addresses those needs.

Mangen Research Associates, http://www.mrainc.com/

In other words, to maximize the wealth of information in the acquired data, one has to dig deeper than the surface. A company needs to understand the characteristics of its target customer, not just the industry they are in. A market analysis will assist one in identifying the universe of target prospects and their demographic make-up, providing the insight necessary to contact them efficiently. This being said, there are a number of methodologies for conducting such a market analysis and segmentation.

Previous attempts have been made to provide personality typing mechanisms or characteristic matching methods as described in U.S. Pat. No. 6,052,122 to Sutcliffe et al. ('122 patent); and U.S. Pat. No. 5,676,551 to Knight et al. ('551 patent); both of which are incorporated herein by reference.

The '122 patent describes a system of matching a first user with at least one other user of the system by comparing criteria data of the first user with characteristic data of the at least one other user and criteria data of the at least one other user with characteristic data of the first user. The characteristic and criteria data can be obtained via the Internet, and more specifically through a series of web site screens that prompt the user for characteristic and preference data. The system performs the comparison of the respective characteristic and criteria data to provide a list of matches to the first user. The first user is furnished with information that allows the first user to contact the other users for which a match has been found.

The '551 patent describes an interactive presentation and/or entertainment system, such as interactive personal computer software and/or interactive television, which allows a participant to modulate the emotions of a character or personality, thereby influencing the branches to an interpersonal relationship over time. As a result, a broad range of computerized dramatic situations or stories are presented that closely resemble human interpersonal relationships. Source image/sound data may include prerecorded video, prerecorded audio, computer-based audio, computer-based imagery, computer-generated dialogue, and/or computer-generated characters. The range of emotional choices made by a participant may include all emotions that human beings can experience and in turn, represent by thought, word, or action. Emotions that indicate personality rather than mood are presented, such that the ebb and flow of a character's emotional states is exhibited over an extended period in the course of a many situations and activities, instead of as mere ephemeral reactions to isolated incidents.

While the above inventions provide characteristic matching or the use of personality criteria or characteristics for finding harmonious personality combinations, they do not describe a method and system of personality typing for market segmentation purposes.

Consequently, there is a need in the art for a method and system of personality typing for market segmentation purposes.

### SUMMARY OF THE INVENTION

Generally described, the present invention provides a method and system of personality typing for market segmentation purposes. Whereby the segment personality type characteristics can be analyzed for providing the most effective, targeted decisions regarding that segment.

In a preferred embodiment of the invention, what is provided is a method for market segmentation, comprising: selecting market criteria data for segmenting a market; selecting characteristic data of the market; combining the market criteria data and the characteristic data to create a selected market; segmenting the selected market by using a personality typing system, thereby producing discrete market segments; analyzing said segments for specific personality traits; and, using the trait analysis for providing maximally effective decisions regarding members of the selected market.

In an alternate embodiment, what is provided is a method for market segmentation using a personality typing system, comprising: selecting market criteria data for segmenting a market; selecting characteristic data of the market; combining the market criteria data and the characteristic data to create a selected market; segmenting the selected market by using a personality typing system, thereby producing discrete market segments; analyzing the segments for specific personality traits; and, using the trait analysis for providing maximally effective decisions regarding members of the selected market.

In another alternate embodiment, what is provided is a method for classifying behavior types for marketing purposes using an enneagram typing system, comprising: selecting market criteria data for segmenting a market; selecting characteristic data of the market; combining the market criteria data and the characteristic data to create a selected market; segmenting the selected market by using an enneagram personality typing system, thereby producing discrete market segments; analyzing the segments for specific personality traits; and, using the trait analysis for providing maximally effective decisions regarding members of the selected market.

In yet another alternate embodiment, what is provided is a system of personality typing for market segmentation, comprising: a print test, wherein the print test defines the top scoring enneagram types for the market segment; a print test tie breaker heuristic, wherein the heuristic clarifies which prints are major and minor prints, not in order; optional print test questions, wherein the questions clarify which prints are major and minor prints, in order; optional test questions to determine Jungian traits; and, other optional tests, including, intelligence tests and skills based tests.

Accordingly, it is an object of the present invention to provide a method and system of personality typing for market segmentation purposes.

These and other objects, features, and advantages of the present invention will become apparent upon reading the following specification when taken in conjunction with the accompanying drawings.

### BRIEF DESCRIPTION OF THE DRAWINGS

FIG. 1 is a view of a preferred embodiment of the market segmentation method according to the invention.

FIG. 2 is a view of a preferred embodiment of the enneagram segmentation means according to the invention.

FIG. 3 is a view of a preferred embodiment of the market segmentation method being used for screening and hiring job candidates, according to the invention.

FIG. 4 is a view of a preferred embodiment of the market segmentation method being used for marketing campaigns, according to the invention.

### DETAILED DESCRIPTION OF THE PREFERRED EMBODIMENT

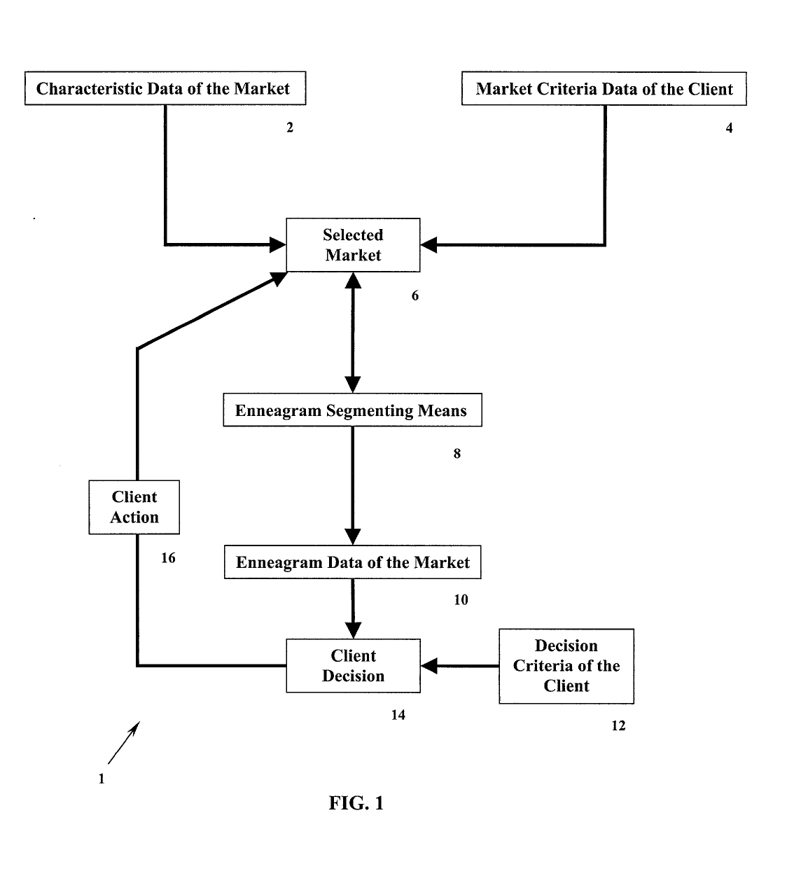

Referring initially to FIG. 1 of the drawings, in which like numerals indicate like elements throughout the several views, in a preferred embodiment the market segmentation system 1 utilizes two basic inputs to determine the selected market 6. The first input, characteristic data of the market 2, defines the targeted market, for example, the market of registered Republican voters, or as another example, people who are looking for a job. The second input is the market criteria data 4 of the client. These criteria 4 define the market on which the company is seeking to concentrate, for example, those people for whom abortion education issues are important, or as another example, those people who are looking to be legal secretaries. The two inputs, 2 and 4, overlay to define the selected market 6. A market can loosely be defined as a collection of people who are segmented or grouped according to a particular purpose or characteristic(s) which could include anything from purchasing behavior, economics, people who attend seminars, political affiliations, people who volunteer for charities, people looking for a job, etc. The enneagram segmentation system is used to understand and make decisions about the market.

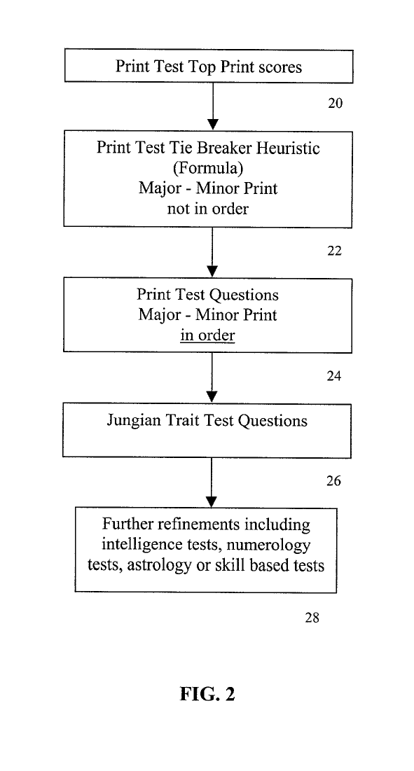

Once the selected market 6 is cemented, the system 1 uses an enneagram segmenting means 8 to convert the market data to enneagram data 10. One method of enneagram segmenting means is discussed more specifically in FIG. 2. The client takes the enneagram data 10 and decision criteria 12 to make a decision 14, (e.g. hiring a person for a job, what keywords to use in advertising spots, etc). The client determines the decision criteria 12 by analyzing the enneagram personality types (“prints”) and identifying those prints that best suit the client's needs. In the job-hiring example, the client may use as its criteria, prints with specific Jungian trait or other refinements such as aptitude tests, intelligence tests, other personality tests, other enneagram variations including: subtypes [self-preservation, relational/intimate (sexual) and social], wings, triads, [(relating, doing, feeling) (instinctive, thinking, feeling)], centers (heart, head, gut), directions of disintegration/integration, Connecting Points (stress and security points), Subtypes of Motivators, Potentialities and Activators, Subgroups of material basis, emotional basis and intellectual basis, Three Archetypes and their subtypes, Relation To Life (way of subjugation, way of mediation, way of reduction), Approach To Problem Solving (aggressive stance, dependent stance, withdrawing stance), Three Centers (creative, intellectual, relational), Three Centers (thinking, feeling, doing), Hornevian Groups (assertives, compliants, withdrawns), Harmonic Groups (positive outlook group, competency group, reactive group), and Triad Personalities (attacher, detacher, defender). In the advertising and marketing example, the client may know that certain words are “trigger” words for specific personality prints and certain images and scenarios are “trigger” images and scenarios for specific personality prints, and therefore should be incorporated into any advertising directed towards that trait group. Once the decision 14 is made, the client effectuates 16 its plan based upon the enneagram data 10 of the market and the pre-determined decision criteria 12.

A preferred embodiment of the enneagram segmentation means 8 is more graphically detailed in FIG. 2. It can be seen from this Figure that the enneagram segmenting means 8 is comprised of a number of elements. The first element is a print test 20 to determine which prints most closely resemble the test subject. The print test 20 does not have to be limited to a traditional paper test, it can be, for example, an online test taken on a computer, a test taken on a computer but not online, it can be a test where the test subject's behavior alone is observed, it can be a test where the test subject's interaction and expression within a group is monitored (for example, in a focus group, or a child in school), the test subject can be interviewed, the test subject can be classified through a process known to those of ordinary skill in the relevant art as paneling, the test subject could listen to a presentation and do comparative analysis to select his or her print, the test subject could be asked to write essay-like answers to questions or could be asked to describe themselves in writing (in a free flow format), or the behavior could be observed in person or videotaped in a training seminar or workshop. These are all alternative methods for using print tests 20 with the enneagram segmentation means 8.

The results of the print test 20 are refined by applying a print test tie-breaker heuristic 22. The heuristic is designed to narrow the pool of prints down to the top two prints, but not necessarily in order. That is, the heuristic 22 establishes the two prints most descriptive of the test subject, but not the major and minor prints, not the ranking of the prints. The major and minor prints are also sometimes known as the major print with wings or the major print with subtypes. The heuristic 22 can be simply a list of statements or adjectives and the subject picks the one that describes him or her more closely and we add them up, or it can be much more complicated.

Once the top two prints are assigned to the test subject, the system 1 can be used to define the major and minor prints of the subject. This is optional, and is only necessary when the exact print combination of the subject is required. This step 24 is achieved by asking the subject a number of questions designed to indicate a dominant print through the answers given by the subject. Ideally, the top two prints discovered above 22, can be ranked major and minor in order based upon these questions 24.

A further refinement can be made to the personality type of the test subject by requiring the subject to submit to a test 26 that determines Jungian traits, such as, for example, a Myers-Briggs type test. The enneagram segmenting means 8 could also be refined by using other mechanisms 28, for example, intelligence tests, numerology tests, aptitude tests, other personality tests, astrology or skill based tests. Other enneagram variations include: subtypes [self-preservation, relational/intimate (sexual) and social], wings, triads, [(relating, doing, feeling) (instinctive, thinking, feeling)], centers (heart, head, gut), direction of disintegration/integration, Connecting Points (stress and security points), Subtypes of Motivators, Potentialities and Activators, Subgroups of material basis, emotional basis and intellectual basis, Three Archetypes and their subtypes, Relation To Life (way of subjugation, way of mediation, way of reduction), Approach To Problem Solving (aggressive stance, dependent stance, withdrawing stance), Three Centers (creative, intellectual, relational), Three Centers (thinking, feeling, doing), Hornevian Groups (assertives, compliants, withdrawns), Harmonic Groups (positive outlook group, competency group, reactive group), and Triad Personalities (attacher, detacher, defender).

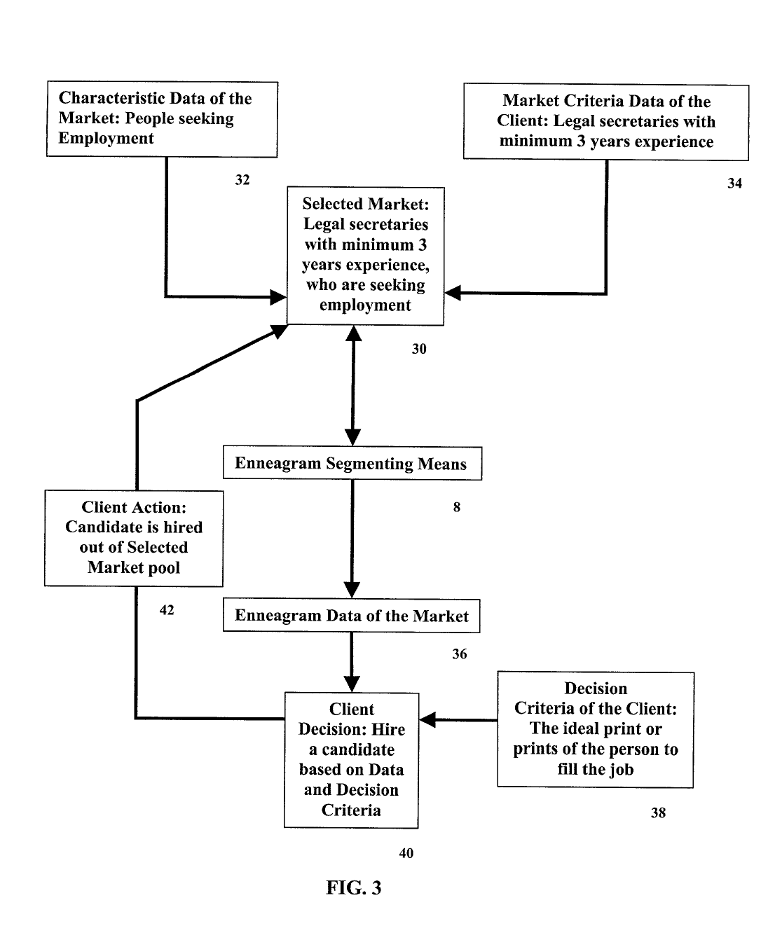

Referring now to FIG. 3, what is provided is a view of a preferred embodiment of the market segmentation method being used for screening and hiring job candidates. As described above, the method would first define the selected market 30. The first input, characteristic data of the market 32, defines the targeted market, in this example, people who are looking for a job. The second input is the market criteria data 34 of the client, the hiring company. In this case, the market criteria data set 34 could be defined as a legal secretary with 3 years of experience minimum. The two inputs, when paired, create the selected market, legal secretaries with a minimum of 3 years of experience who are looking for a job. The applicants in the selected market are then personality typed using the enneagram segmentation means 8, detailed in FIG. 2. In this type of situation the client may have pre-determined the ideal candidate's print(s), perhaps being refined to the point of knowing the order of major/minor prints and the Jungian traits (or other refinements described previously). These predetermined ideal prints are known as the decision criteria 12 in FIG. 1. Once the enneagram data of the market 36 is determined (the specific print of each candidate is determined), the client can apply the decision criteria 38 to identify the most appropriate candidate in the market segment. The client selecting 40 and hiring a candidate 42 concludes the process.

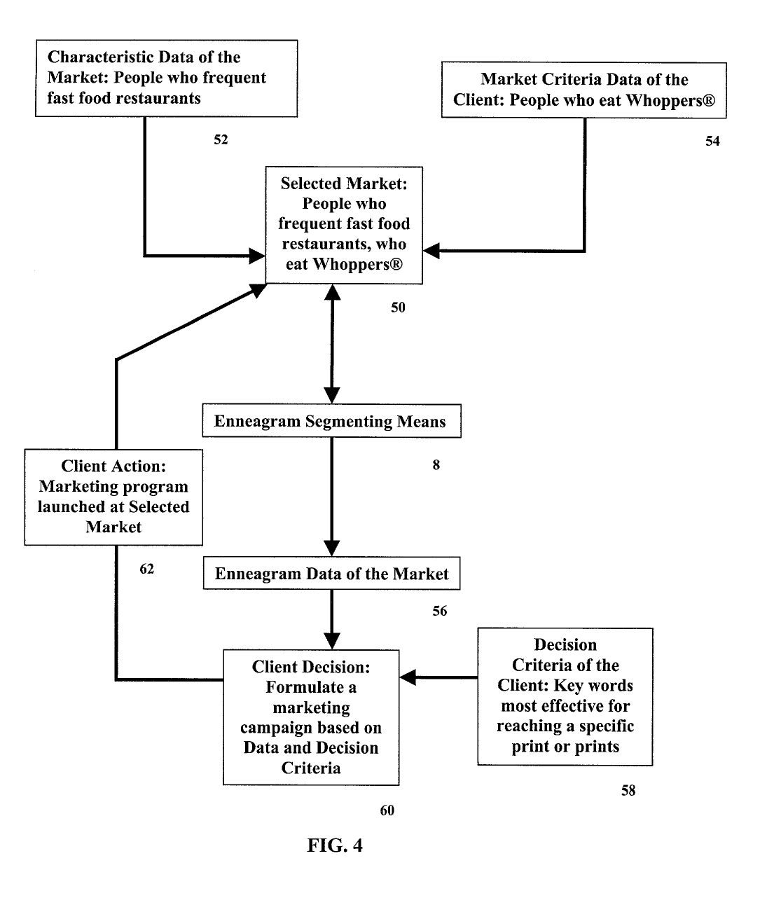

FIG. 4 illustrates how the present system 1, can be used for marketing and advertising purposes. In this scenario, the characteristic data of the market 52, could be those people who patronize fast food establishments. The market criteria data 54 could specify that the client is only interested in the people who prefer to eat the Burger King® Whopper® sandwich. The selected market 50 is therefore those people who eat at fast food restaurants and specifically choose to eat the Whopper® over other sandwiches. The enneagram segmentation means 8 is then used to print those Whopper® lovers, the goal being to identify which personality prints patronize Burger King® for the Whopper® sandwich. The enneagram data 56 produced is used by the client to make marketing decisions by coupling the enneagram data 56 with the decision criteria 58. In this case, the decision criteria 58 are pre-defined words, images or scenarios to which certain personality prints are attracted. For example, the data 56 could show that personality prints 3 and 7 are Whopper® lovers, and that 3s and 7s are attracted to words such as “fast” and “powerful”, and images or scenarios that illustrate people doing things quickly and people being in control and making their own decisions. Therefore, “fast” and “powerful” are in the data set that defines the decision criteria 58. The client then proceeds to launch 60, 62 a marketing campaign utilizing the 3 and 7 key words, images or scenarios.

A useful enhancement to the system would be in generating a database of the likes and dislikes of the different personality prints. For example, cars they drive, movies they watch, food they eat, magazines they read, television shows they watch, music they listen to, etc., including, but not limited to, anyone that you'd want to contact or reach with targeted Print-specific information.

Accordingly, it will be understood that the preferred embodiment of the present invention has been disclosed by way of example and that other modifications and alterations may occur to those skilled in the art without departing from the scope and spirit of the appended claims.

The invention claimed is:

1. A method for market segmentation, comprising:
selecting market criteria data for segmenting a market;
selecting characteristic data of said market;
combining said market criteria data and said characteristic data to create a selected market;
segmenting said selected market by using a personality typing system, thereby producing discrete market segments;
analyzing said segments for specific personality traits; and
using said trait analysis for providing maximally effective decisions regarding members of said selected market.

2. The method of claim 1, whereby market sub-segments may further be produced by said segmenting.

3. The method of claim 1, whereby said personality typing system consists of an enneagram print test and a print test tie breaker heuristic.

4. The method of claim 3, whereby said method further comprises Jungian personality typing tests, intelligence tests, and skills based tests.

5. A method for market segmentation using a personality typing system, comprising:
selecting market criteria data for segmenting a market;
selecting characteristic data of said market;
combining said market criteria data and said characteristic data to create a selected market;
segmenting said selected market by using a personality typing system, thereby producing discrete market segments;
analyzing said segments for specific personality traits; and,
using said trait analysis for providing maximally effective decisions regarding members of said selected market.

6. A method as in claim 5, whereby market sub-segments may also be produced by said segmenting.

7. A method as in claim 5, whereby said personality typing system consists of an enneagram print test and a print test tie breaker heuristic.

8. The method of claim 7, whereby said system further comprises Jungian personality typing tests, intelligence tests, and skills based tests.

9. A method for market segmentation using an enneagram for personality typing, comprising:
selecting market criteria data for segmenting a market;
selecting characteristic data of said market;
combining said market criteria data and said characteristic data to create a selected market;
segmenting said selected market by using a personality typing system, thereby producing discrete market segments;
analyzing said segments for specific personality traits; and,
using said trait analysis for providing maximally effective decisions regarding members of said selected market.

10. A method as in claim 9, whereby market sub-segments may further be produced by said segmenting.

11. A method for classifying behavior types for marketing purposes using an enneagram typing system, comprising:
selecting market criteria data for segmenting a market;
selecting characteristic data of said market;
combining said market criteria data and said characteristic data to create a selected market;
segmenting said selected market by using a personality typing system, thereby producing discrete market segments;
analyzing said segments for specific personality traits; and,
using said trait analysis for providing maximally effective decisions regarding members of said selected market.

12. A method as in claim 11, whereby market sub-segments may further be produced by said segmenting.

13. A method as in claim 11, whereby said enneagram typing system provides major and minor enneagram prints, with optional Jungian traits, and comprises:
a print test, wherein said print test defines the top scoring enneagram types for the market segment;
a print test tie breaker heuristic, wherein said heuristic clarifies which prints are major and minor prints, not in order;
optional print test questions, wherein said questions clarify which prints are major and minor prints, in order;
optional test questions to determine Jungian traits; and,
other optional tests, including, intelligence tests and skills based tests.

14. A system of personality typing for market segmentation, comprising:
a print test, wherein said print test defines the top scoring enneagram types for the market segment;
a print test tie breaker heuristic, wherein said heuristic clarifies which prints are major and minor prints, not in order;
optional print test questions, wherein said questions clarify which prints are major and minor prints, in order;
optional test questions to determine Jungian traits; and,
other optional tests, including, intelligence tests and skills based tests.
